(19) United States
(12) Patent Application Publication
(10) Pub. No.: US 2025/0244175 A1
(43) Pub. Date: Jul. 31, 2025

(54) OPTICAL SENSOR MECHANISM CAPABLE OF EFFECTIVELY MITIGATING THE TEMPERATURE VARIATION CAUSED BY ADJACENT HEATER DEVICE

(71) Applicant: PixArt Imaging Inc., Hsin-Chu City (TW)

(72) Inventors: Ming-Han Tsai, Hsin-Chu City (TW); Po-Wei Yu, Hsin-Chu City (TW)

(73) Assignee: PixArt Imaging Inc., Hsin-Chu City (TW)

(21) Appl. No.: 18/426,285

(22) Filed: Jan. 29, 2024

(51) Int. Cl. G01J 5/061; G01J 5/06

(52) U.S. Cl. CPC G01J 5/061; G01J 2005/063; G01J 2005/065

(57) ABSTRACT

An optical sensor circuit of an optical sensor device to be disposed on and to be heated by a heater device is provided. The optical sensor device further includes a printed circuit, a first heat shielding portion, and a heat conduction device. The optical sensor circuit is disposed on a top surface of the printed circuit. The first heat shielding portion has a top surface contacting a bottom surface of the printed circuit. The heat conduction device has a first portion and a second portion, and the first portion of the heat conduction device is disposed between the first heat shielding portion and a top surface of the heater device. The second portion of the heat conduction device surrounds the optical sensor circuit.

### BACKGROUND OF THE INVENTION

### 1. Field of the Invention

The invention relates to an optical sensor mechanism, and more particularly to an optical sensor device and an optical sensor circuit.

### 2. Description of the Prior Art

Generally speaking, the performance of a conventional optical sensor circuit may be affected by an adjacent heater device. For example, the conventional optical sensor circuit may be used as a temperature detection sensor which can be used to sense an object's temperature occurring within the field of view of the conventional optical sensor circuit, and the accuracy of the temperature detection operation will be affected if the temperature provided from the adjacent heater device significantly varies. That is, the result of temperature detection operation is inaccurate.

### SUMMARY OF THE INVENTION

Therefore one of the objectives of the invention is to provide an optical sensor device, to solve the above-mentioned problems.

According to the embodiments, an optical sensor device, to be disposed on and to be heated by a heater device, is disclosed. The optical sensor device comprises a printed circuit, an optical sensor circuit, a first heat shielding portion, and a heat conduction device. The optical sensor circuit is disposed on a top surface of the printed circuit. The first heat shielding portion has a top surface contacting a bottom surface of the printed circuit. The heat conduction device has a first portion and a second portion, and the first portion of the heat conduction device is disposed between the first heat shielding portion and a top surface of the heater device. The second portion of the heat conduction device surrounds the optical sensor circuit.

According to the embodiments, an optical sensor circuit of an optical sensor device to be disposed on and to be heated by a heater device is disclosed. The optical sensor device further comprises a printed circuit, a first heat shielding portion, and a heat conduction device. The optical sensor circuit is disposed on a top surface of the printed circuit. The first heat shielding portion has a top surface contacting a bottom surface of the printed circuit. The heat conduction device has a first portion and a second portion, and the first portion of the heat conduction device is disposed between the first heat shielding portion and a top surface of the heater device. The second portion of the heat conduction device surrounds the optical sensor circuit.

According to the embodiments, an electric apparatus is disclosed. The electric apparatus comprises a housing, an infrared sensor circuit, and a thermal insulating material. The infrared sensor circuit is disposed inside the housing and configured to sense an temperature of an object outside the housing. The infrared sensor circuit is indirectly contacted with the housing. The thermal insulating material is disposed between the infrared sensor circuit and the housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electric apparatus such as an optical sensor device according to a first embodiment of the invention.

FIG. 2 is a diagram of an electric apparatus such as an optical sensor device according to a second embodiment of the invention.

FIG. 3 is a diagram of an electric apparatus such as an optical sensor device according to a third embodiment of the invention.

FIG. 4 is a diagram of an electric apparatus such as an optical sensor device according to a fourth embodiment of the invention.

FIG. 5 is a diagram of an electric apparatus such as an optical sensor device according to a fifth embodiment of the invention.

FIG. 6 is a diagram of an electric apparatus such as an optical sensor device according to a sixth embodiment of the invention.

FIG. 7 is a diagram of an electric apparatus such as an optical sensor device according to a seventh embodiment of the invention.

FIG. 8 is a diagram of an example of an electric apparatus such as an optical sensor device according to another different embodiment of the invention.

### DETAILED DESCRIPTION

The invention aims at providing an optical sensor device capable of effectively shielding heat of a heater device from the optical sensor device as well as uniformly dissipating heat generated from the heater device so as to mitigate the temperature variation sensed by the optical sensor device caused due to the heat of the heater device.

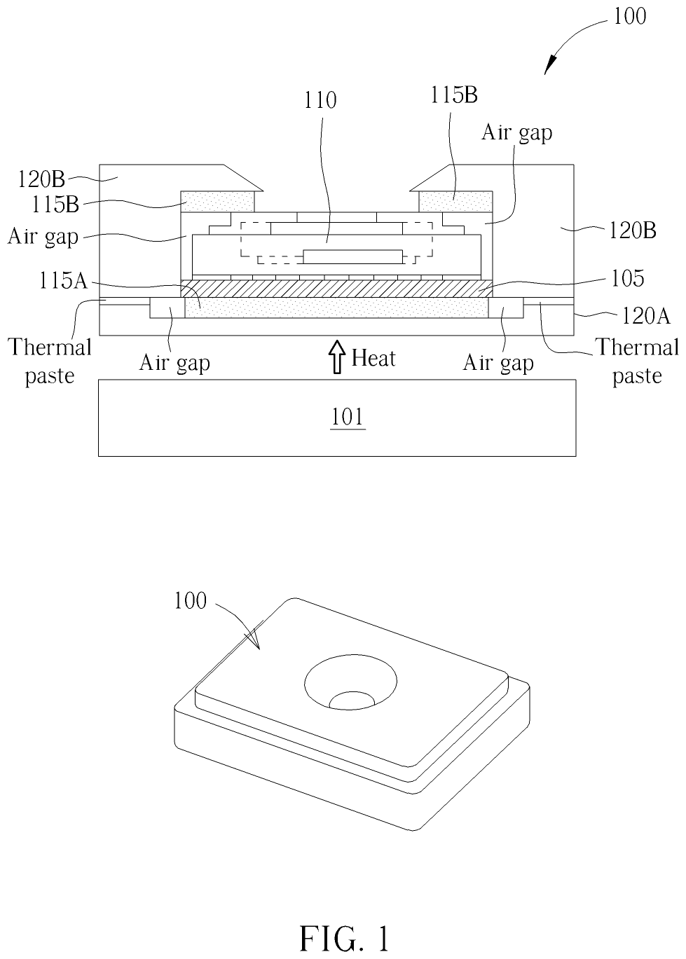

FIG. 1 is a diagram of overall appearance and sectional view of an electric apparatus such as an optical sensor device 100 according to an embodiment of the invention. In FIG. 1, the optical sensor device 100 for example is to be disposed on and to be heated by a heater device 101 as shown in FIG. 1; the heater device 101 may heat the optical sensor device 100 through the bottom surface of the optical sensor device 100 by using a significantly variable temperature range. For example (but not limited), the heating temperature provided from the heater device 101 may vary from a lower temperature value such as 20° C. to a higher temperature value such as 85° C. and then rapidly vary from the higher temperature value such as 85° C. to the lower temperature value such as 20° C.

To avoid the significantly varied heating temperature affecting the performance of the optical sensor device 100, the optical sensor device 100 is arranged to shield heat of the heater device 101 from the optical sensor device 100 as well as uniformly dissipating heat generated from the heater device 101. In practice, as shown in FIG. 1, the optical sensor device 100 comprises a printed circuit 105 such as a flexible printed circuit (FPC) or a printed circuit board (PCB), an optical sensor circuit 110 installed and disposed on a top surface of the printed circuit 105, a first heat shielding portion 115A, a second heat shielding portion 115B, and a heat conduction device 120. In an example, the printed circuit 105 may be an FPC with a steel material or other different materials or is may be a PCB. This is not intended to be a limitation of the invention.

The first heat shielding portion 115A for example is a bottom heat shielding portion (compared to the position of the optical sensor circuit 110) and it has a top surface contacting and fixing a bottom surface of the printed circuit and has a bottom surface contacting and fixing the portion 120A of heat conduction device 120. For example, the top surface of the first heat shielding portion 115A may be substantially equal to or larger than the bottom surface of the printed circuit 105 to shield heat of the heater device 101 transferred and passed through the portion 120A of the heat conduction device 120.

The second heat shielding portion 115B for example is a top heat shielding portion (compared to the position of the optical sensor circuit 110), and it has a top surface contacting and fixing the another portion 120B of heat conduction device 120 and has a bottom surface which has a partial surface being used to contact and fix a partial surface of the top surface of the optical sensor circuit 110. The second heat shielding portion 115B is used to shield heat of the heater device 101 transferred and passed through the another portion 120B of the heat conduction device 120.

The heat conduction device 120 has the first portion 120A and the second portion 120B, and the first portion 120A of the heat conduction device 120 is disposed between the first heat shielding portion 115A and the top surface of the heater device 101. The second portion 120B of the heat conduction device 120 surrounds the optical sensor circuit 110.

In this embodiment, as shown in FIG. 1, for example (but not limited), the optical sensor circuit 110 has a cylinder-like shape having a curved side surface and may have an optical filter disposed on the top of the optical sensor circuit 110. The optical sensor circuit 110 for instance is a far-infrared (FIR) sensor which can be used to detect a temperature of an object seen by and within the field of view of the optical sensor circuit 110.

The first heat shielding portion 115A may be implemented by using a sponge material and the top/bottom surface of the first heat shielding portion 115A may be a circle-like shape or a rectangular-like shape (but not limited). The top surface of the first heat shielding portion 115A is arranged to contact the bottom surface of the printed circuit 105, and the bottom surface of the first heat shielding portion 115A is arranged to contact and disposed on an area of an inner surface of the first portion 120A of the heat conduction device 120.

The first portion 120A of the heat conduction device 120 may be equivalently used as a base case to contact and fix/hold the bottom surface of first/bottom heat shielding portion 115A and support the printed circuit 105 and optical sensor circuit 110, and also it is used to uniformly/evenly dissipate heat generated from the heater device 101 which is below the optical sensor device 100 while simultaneously the first/bottom heat shielding portion 15A is used to separate the printed circuit 105 and the first portion 120A of the heat conduction device 120 so as to effectively shield heat from the heater device 101 which is below the optical sensor device 100. In one embodiment, the first portion 120A of the heat conduction device 120 may comprise a box-shape case such as a lunchbox-shape base case with a specific metal material such as the aluminum material or other metal materials which can be used to conduct heat efficiently.

In one embodiment, the second portion 120B of the heat conduction device 120 may comprise a box-shape case such as a lunchbox-shape lid case with a center circle hole which has a circular edge portion being arranged to contact and to fix the top surface of the second/top heat shielding portion 115B such as another sponge material which can be used to separate the second portion 120B of the heat conduction device 120 from the optical sensor circuit 110. In one embodiment, the first portion 120A of heat conduction device 120 is arranged to uniformly dissipate heat, and the second portion 120B of heat conduction device 120 may be replaced by a cover case being implemented by a non-thermal conductive material; however, this is not a limitation of the invention. In one embodiment, the first portion 120A of heat conduction device 120 is arranged to work together with the second portion 120B of heat conduction device 120 to more evenly and more efficiently dissipate heat from the optical sensor device 100 into the ambient air.

Further, in one embodiment, the first/bottom portion 120A of the heat conduction device 120 may comprise a round/oblong base plate with a raised circular portion at the edge of the top of the round/oblong base plate wherein the raised circular portion may be equivalently regarded as a circular side wall at the top of the round/oblong base plate, as shown in FIG. 1. Alternatively, in other embodiments, the first/bottom portion 120A of the heat conduction device 120 may be merely a round/oblong base plate without a raised portion at its top. This modification also falls within the scope of the invention.

Equivalently, the second/top portion 120B of the heat conduction device 120 may be regarded as an oblong box cover with a center circular opening, which can be used to fit the round top of the optical sensor circuit 110 with the curved side and also to fit and/or fix the first/bottom portion 120A of the heat conduction device 120. For example, the second/top portion 120B of the heat conduction device 120 may be pasted and fixed to the first/bottom portion 120A of the heat conduction device 120 by using a thermal paste/glue (or a non-thermal paste). The thermal paste/glue may be applied on the top of the circular side wall at the top of the round/oblong base plate of the first/bottom portion 120A of the heat conduction device 120, and then the second/top portion 120B of heat conduction device 120 is pushed to make the bottom of the second/top portion 120B of heat conduction device 120 seamlessly contact and fix the first/bottom portion 120A of the heat conduction device 120 through the thermal paste/glue.

Further, in one embodiment, the first/bottom portion 120A of the heat conduction device 120 and the second/top portion 120B of heat conduction device 120 may be integrally formed without thermal paste/glue. In other embodiment, first/bottom portion 120A of the heat conduction device 120 and the second/top portion 120B of heat conduction device 120 may be one-piece-formed under a condition that the optical sensor circuit 110 can be installed within an one-piece-formed unit. In one embodiment, the used thermal paste may be a thermal compound material. Further, for example (but not limited), the optical sensor device 100 may be a small circuit package device which have a length of 19 mm (millimeter), a width of 14 mm, and a height of 5.2 mm as shown in FIG. 1.

In the embodiment of FIG. 1, the second/top portion 120B of heat conduction device 120 is further used to hold/keep the optical sensor circuit 110 by using a partial portion of the second/top portion 120B of heat conduction device 120 to contact the side of printed circuit 105 to make the printed circuit 105 be properly and exactly stuck in the second/top portion 120B of heat conduction device 120. As shown in FIG. 1, the air gap exists between the inner side of first/bottom portion 120A of heat conduction device 120 and the side of first heat shielding portion 115A, and also another air gap may exist between the inner side of second/top portion 120B of heat conduction device 120 and the side of optical sensor circuit 110.

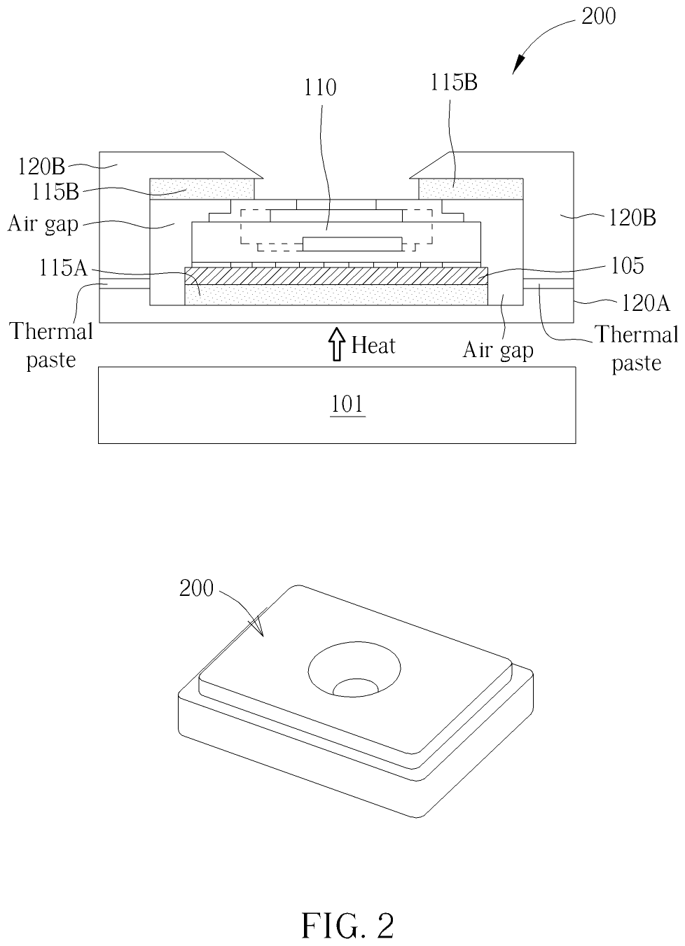

FIG. 2 is a diagram of overall appearance and sectional view of an electric apparatus such as an optical sensor device 200 according to another embodiment of the invention. In FIG. 2, the thickness of the side of the second/top portion 120B of heat conduction device 120 is substantially identical to that of the side of the first/bottom portion 120A of heat conduction device 120, i.e. the inner side of the heat conduction device 120 is flat. As shown in FIG. 2, an air gap exists between the heat conduction device 120 and the optical sensor circuit 110.

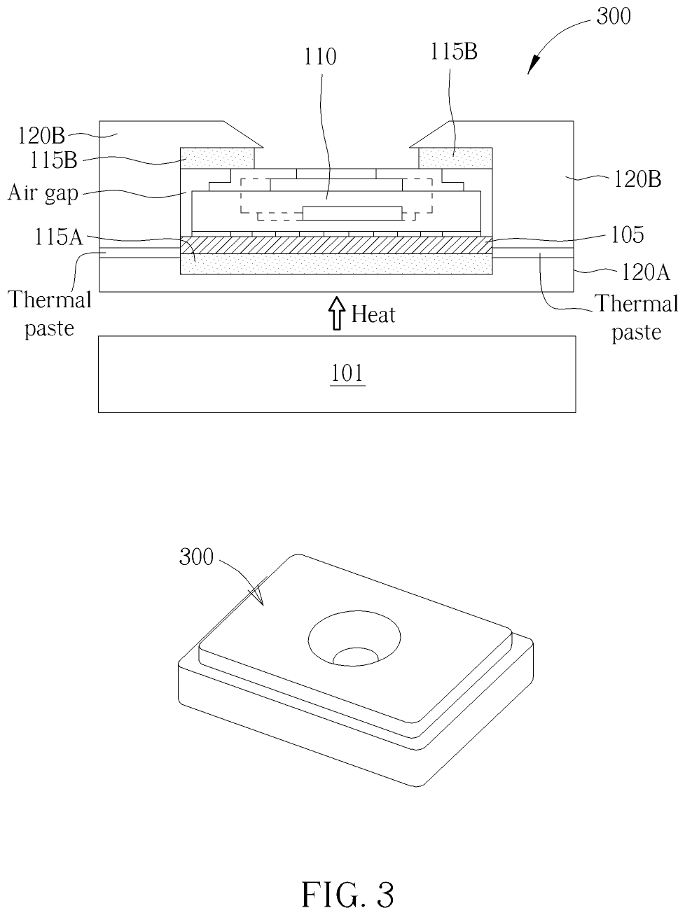

FIG. 3 is a diagram of overall appearance and sectional view of an electric apparatus such as an optical sensor device 300 according to another embodiment of the invention. In FIG. 3, the thickness of the side of the second/top portion 120B of heat conduction device 120 is substantially identical to that of the side of the first/bottom portion 120A of heat conduction device 120, i.e. the inner side of the heat conduction device 120 is flat. The second/top portion 120B of heat conduction device 120 is used to hold/keep the optical sensor circuit 110 by using a partial portion of the second/top portion 120B of heat conduction device 120 to contact the side of printed circuit 105 to make the printed circuit 105 be properly and exactly stuck in the second/top portion 120B of heat conduction device 120, and the first/bottom portion 120A of heat conduction device 120 is also used to hold/keep the first heat shielding portion 115A to make the first heat shielding portion 115A be properly and exactly stuck in the bottom portion 120A of heat conduction device 120, i.e. no air gaps exist between the side of first heat shielding portion 115A and the inner side of the first/bottom portion 120A of heat conduction device 120.

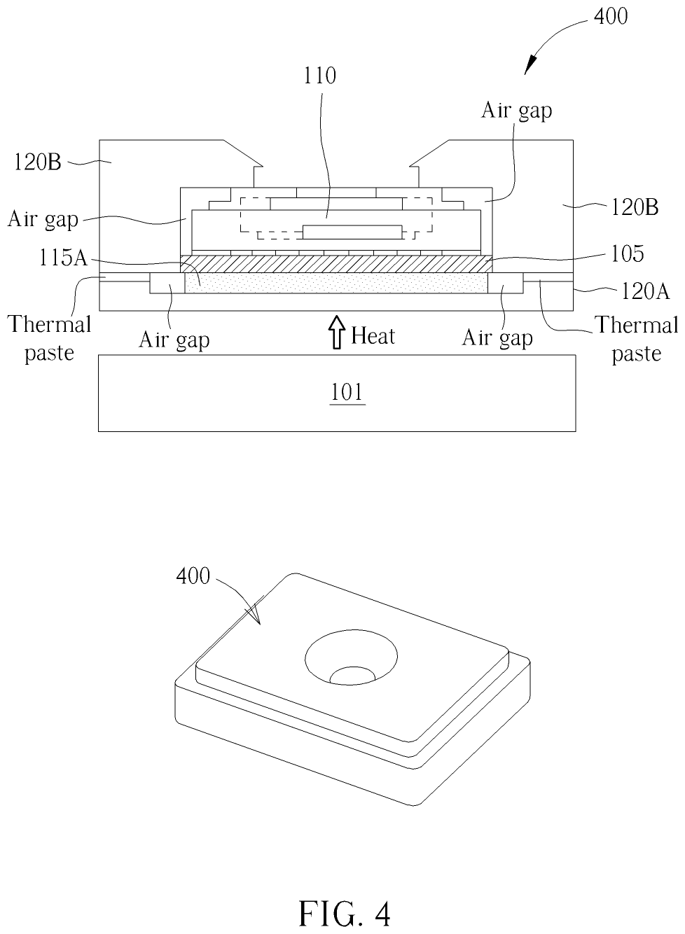

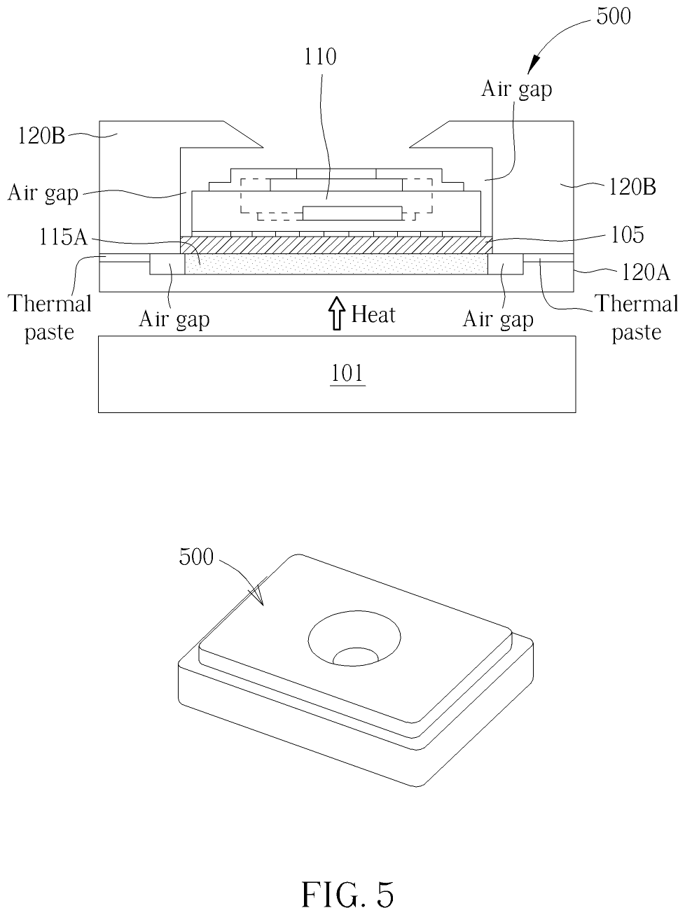

FIG. 4 is a diagram of overall appearance and sectional view of an electric apparatus such as an optical sensor device 400 according to another embodiment of the invention. In FIG. 4, the second/top heat shielding portion 115B may be optional and is excluded by the optical sensor device 400. A partial portion of the second/top portion 120B of heat conduction device 120 may contact the edge of the top of the optical sensor circuit 110. Alternatively, in other embodiments, FIG. 5 is a diagram of overall appearance and sectional view of an electric apparatus such as an optical sensor device 500 according to another embodiment of the invention. In FIG. 5, the second/top heat shielding portion 115B may be optional and is excluded by the optical sensor device 500. The second/top portion 120B of heat conduction device 120 does not contact the optical sensor circuit 110.

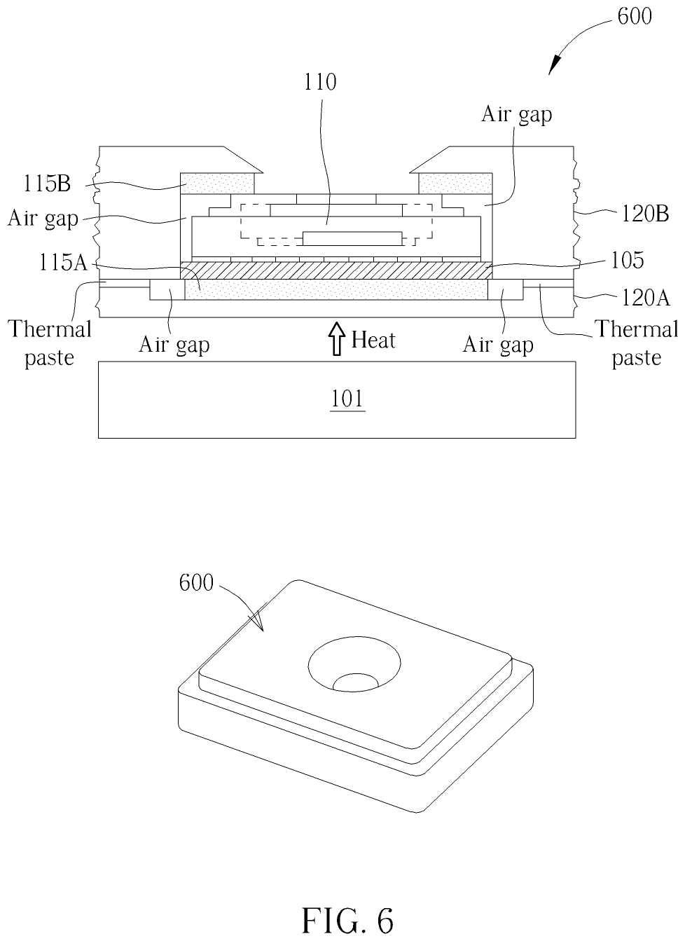

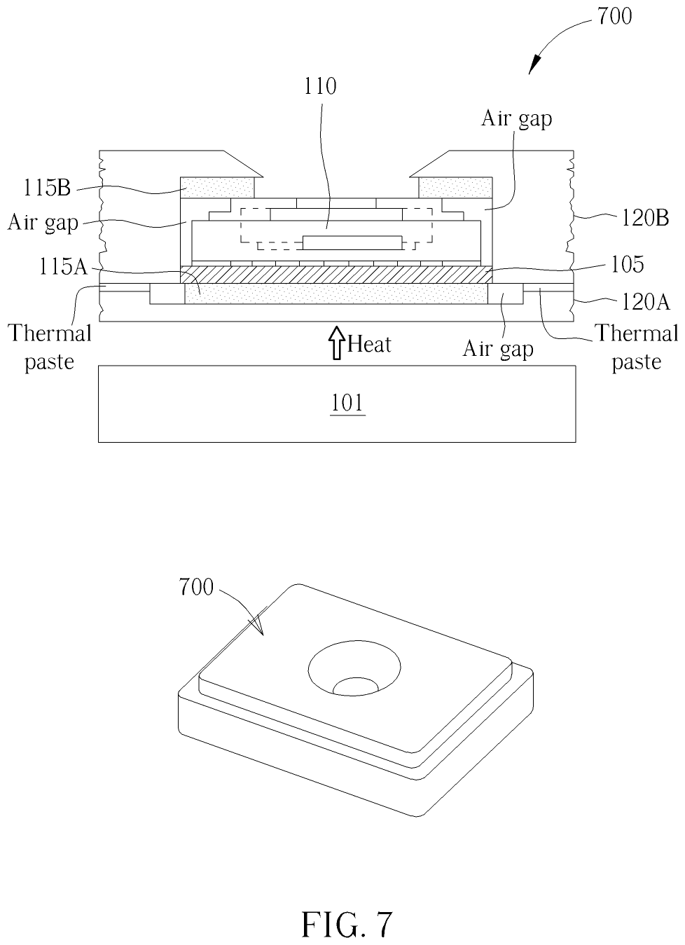

Further, in other embodiments, a plurality of surface protrusions can be disposed on an outer surface of at least one of the first portion 120A and the second portion 120B of the heat conduction device 120, so as to increase the total surface area of the heat conduction device 120 to more efficiently and fast dissipate heat. FIG. 6 shows an example of the outer surface of heat conduction device 120 having surface protrusions according to an embodiment of the invention. Alternatively, in one embodiment, a plurality of surface pits can be disposed on an outer surface of at least one of the first portion 120A and the second portion 120B of the heat conduction device 120, so as to increase the total surface area of the heat conduction device 120 to more efficiently and fast dissipate heat. FIG. 7 shows an example of the outer surface of heat conduction device 120 having surface pits according to an embodiment of the invention. The modifications all obey the spirits of the invention.

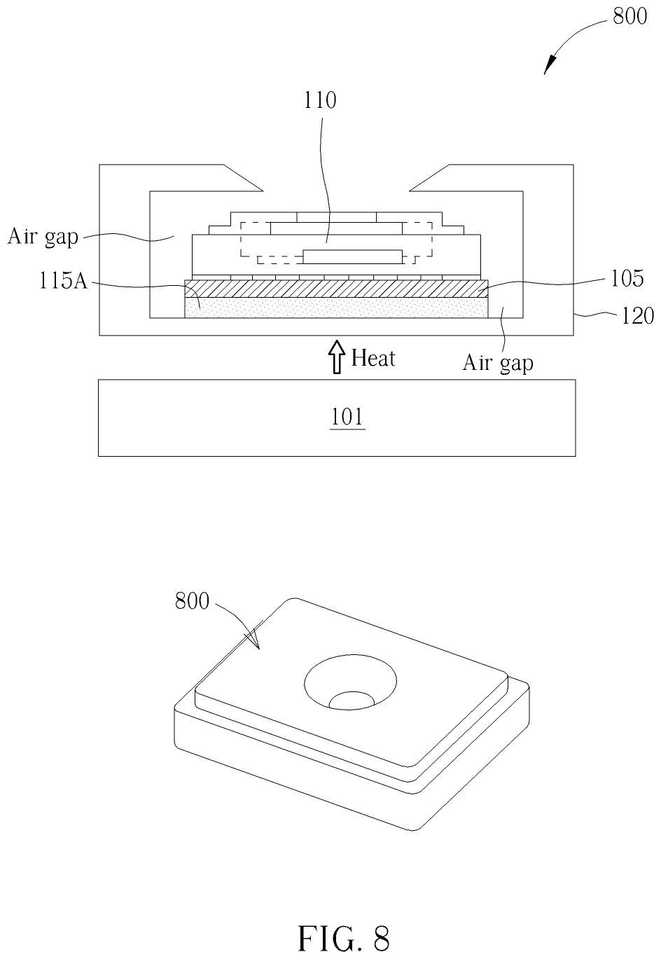

FIG. 8 is a diagram of an example of an electric apparatus such as an optical sensor device 800 according to another different embodiment of the invention. The electric apparatus 800 comprises a housing such as a heat conduction device 120, an infrared sensor circuit (which is formed by an optical sensor circuit 110 and a printed circuit board 105), and a thermal insulting material such as a heat shielding portion 115A. For example, in FIG. 8, the infrared sensor circuit 110 is disposed inside the housing 120 and configured to sense a temperature of an object outside the housing 120. The infrared sensor circuit (i.e. the optical sensor circuit 110 with the printed circuit board 105) is indirectly contacted with the housing 120. The thermal insulating material 115A is disposed between the infrared sensor circuit (i.e. the optical sensor circuit 110 with the printed circuit board 105) and the housing 120 equivalently. In addition, an air gap exists between the housing 120 and the infrared sensor circuit. In addition, the infrared sensor circuit (i.e. the optical sensor circuit 110 with the printed circuit board 105) is located on a top surface of the thermal insulating material 115A, and a bottom surface of the thermal insulating material 115A is contacted onto a top surface of a plate of the housing 120.

Based on the device structures mentioned above, when the temperature provided by the heater device 101 significantly varies, an object's temperature seen and detected by the optical sensor circuit 110 will not significantly affected and varied. For example, when the temperature provided by the heater device 101 significantly varies between a lower temperature such as 20° C. and a higher temperature such as 85° C., the object's temperature seen and detected by a conventional optical sensor may have a significant temperature variation such as almost 30° C. Compared to the conventional optical sensor, the optical sensor circuit 110 may merely have a slight temperature variation such as 5° C. at most when the temperature provided by the heater device 101 significantly varies between 20° C. and 85° C. The optical sensor devices provided in the embodiments of the invention equivalently can more precisely detect an object's temperature.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical sensor device to be disposed on and to be heated by a heater device, comprising:
a printed circuit;
an optical sensor circuit, disposed on a top surface of the printed circuit;
a first heat shielding portion, having a top surface contacting a bottom surface of the printed circuit; and
a heat conduction device, having a first portion and a second portion, the first portion of the heat conduction device being disposed between the first heat shielding portion and a top surface of the heater device, and the second portion of the heat conduction device surrounding the optical sensor circuit.

2. The optical sensor device of claim 1, further comprising:
a second heat shielding portion, disposed between a top surface of the optical sensor circuit and the second portion of the heat conduction device.

3. The optical sensor device of claim 2, wherein the optical sensor circuit and the printed circuit are disposed between the first heat shielding portion and the second heat shielding portion, and the first heat shielding portion and the second heat shielding portion are surrounded by the heat conduction device.

4. The optical sensor device of claim 1, wherein the first portion of the heat conduction device is fixed to the second portion of the heat conduction device through a thermal compound material.

5. The optical sensor device of claim 1, wherein the first portion of the heat conduction device and the second portion of the heat conduction device are integrally formed.

6. The optical sensor device of claim 5, wherein the first portion of the heat conduction device and the second portion of the heat conduction device are one-piece-formed.

7. The optical sensor device of claim 1, wherein a plurality of surface protrusions are disposed on an outer surface of at least one of the first portion and the second portion of the heat conduction device.

8. The optical sensor device of claim 1, wherein a plurality of surface pits are disposed on an outer surface of at least one of the first portion and the second portion of the heat conduction device.

9. An optical sensor circuit of an optical sensor device to be disposed on and to be heated by a heater device, wherein the optical sensor device further comprises a printed circuit, a first heat shielding portion, and a heat conduction device; the optical sensor circuit is disposed on a top surface of the printed circuit; the first heat shielding portion has a top surface contacting a bottom surface of the printed circuit; the heat conduction device has a first portion and a second portion, and the first portion of the heat conduction device is disposed between the first heat shielding portion and a top surface of the heater device; and, the second portion of the heat conduction device surrounds the optical sensor circuit.

10. The optical sensor circuit of claim 9, wherein the optical sensor device further comprises a second heat shielding portion, and the second heat shielding portion is disposed between a top surface of the optical sensor circuit and the second portion of the heat conduction device.

11. The optical sensor circuit of claim 10, wherein the optical sensor circuit and the printed circuit are disposed between the first heat shielding portion and the second heat shielding portion, and the first heat shielding portion and the second heat shielding portion are surrounded by the heat conduction device.

12. The optical sensor circuit of claim 9, wherein the first portion of the heat conduction device is fixed to the second portion of the heat conduction device through a thermal compound material.

13. The optical sensor circuit of claim 9, wherein the first portion of the heat conduction device and the second portion of the heat conduction device are integrally formed.

14. The optical sensor circuit of claim 13, wherein the first portion of the heat conduction device and the second portion of the heat conduction device are one-piece-formed.

15. The optical sensor circuit of claim 9, wherein a plurality of surface protrusions are disposed on an outer surface of at least one of the first portion and the second portion of the heat conduction device.

16. The optical sensor circuit of claim 9, wherein a plurality of surface pits are disposed on an outer surface of at least one of the first portion and the second portion of the heat conduction device.

17. An electric apparatus, comprising:
a housing;
an infrared sensor circuit, disposed inside the housing and configured to sense an temperature of an object outside the housing, wherein the infrared sensor circuit is indirectly contacted with the housing; and
a thermal insulating material, disposed between the infrared sensor circuit and the housing.

18. The electronic apparatus of claim 17, wherein an air gap exist between the housing and the infrared sensor circuit.

19. The electric apparatus of claim 17, wherein the infrared sensor circuit is located on a top surface of the thermal insulating material, and a bottom surface of the thermal insulating material is contacted onto a top surface of a plate of the housing.
